(19) United States
(12) Patent Application Publication
(10) Pub. No.: US 2005/0240453 A1
(43) Pub. Date: Oct. 27, 2005

(54) Home ticketing system

(76) Inventor: Scott Lyons, Buena Park, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(21) Appl. No.: 11/109,184

(22) Filed: Apr. 18, 2005

Related U.S. Application Data
(60) Provisional application No. 60/564,440, filed on Apr. 21, 2004.

(51) Int. Cl. G06F 17/60

(52) U.S. Cl. 705/5

(57) ABSTRACT

A system and method for accessing a venue, such as an amusement park, on one or more days, using an electronic ticket purchased over one's home computer and converted to a hard ticket at the venue.

### CROSS REFERENCE TO RELATED APPLICATION

This application claims the benefit of provisional application Ser. No. 60/564,440, filed Apr. 21, 2004, the contents of which are incorporated by reference herein in their entirety.

### BACKGROUND

1. Field

The invention relates to home ticketing systems; and, more particularly, to a system and method for printing a ticket to a venue at home and utilizing that printed ticket to obtain a replacement ticket at the venue allowing access to the venue.

2. Related Art

The printing of tickets at home (“etickets”) using a home computer, such as for airline tickets, is well known.

Certain venues, such as amusement parks, generally have long lines of people waiting to purchase admission.

Some such venues, sell single-use print-at-home tickets, but do not sell multi-day tickets. If such were available, a person could purchase a multi-day ticket, and send a copy to one or more friends, thus allowing each person to use their copy of the multi-day ticket on different days.

There is a need for a system wherein an electronic ticket or an eticket may be printed on one's home computer which can be replaced at the venue entrance allowing quick admission into the park. Those guests using etickets should be able to enter the park with equal convenience to those who have purchased tickets at the park.

There is a need for a system and method wherein multi-day tickets to a venue can be printed at home with a permanent multi-day ticket being substituted at the venue for the multi-day eticket printed at home. Any electronic copies of that ticket are invalidated when the permanent ticket is issued.

### SUMMARY OF THE DISCLOSURE

It is an object of this invention to provide a system and method for printing tickets to a venue, such as an amusement park, which ticket is exchanged at the venue for a replacement ticket allowing all entitlements included with the ticket.

Potential guests to an amusement park or the like can access their home computer, connect their browser to a remote server over the internet, enter certain information, such as a desired date or dates or length of stay for visiting the venue, pay for a ticket using a credit card or the like, then print out an eticket at home according to instructions received by email from the server. Alternatively, the user may be sent to a URL where the ticket is printed.

These etickets are printed on separate pages with a random bar code assigned to each ticket by the system. When the user takes that ticket to the venue, the user presents the ticket to an exchange location at the venue entrance, such as a kiosk, turnstile, etc. where the eticket is scanned and a replacement ticket is issued. Thus, the replacement ticket replaces the eticket which is of course no longer used and any fraudulent duplicate etickets cannot be used to obtain a replacement ticket.

### BRIEF DESCRIPTION OF THE PREFERRED EMBODIMENT

As particularly contemplated in the present invention, a potential guest to a venue, such as an amusement park, will access a remote server over the internet using a conventional web browser. Based on information from the user to the server, and after suitable payment, such as by credit card, validation instructions are conveyed by the server to the user such as by email or direct access, allowing the user to print a single or multi-day eticket at home. This ticket has no admission value and cannot be used for admission to the venue until replaced with an actual venue admission ticket. Thus, if fraudulently duplicated, as will be discussed further hereinbelow, only the first eticket presented for admission to the venue will be honored. All other copies will be invalid.

When the eticket is presented for the first time at the venue, such as a kiosk or the like at the venue entrance, a permanent ticket, either single or multi-day, is issued. Any electronic copies that may be floating around are thus invalid. Since the eticket that was printed at home, and which eticket may be printed on various sized papers and various weights of paper and is now substituted for a replacement ticket, the latter will be identical to a ticket used at the venue. That is, it will have the same dimensions, encoding, be of the same stock, etc., allowing the guest easy access to the venue, e.g., re-entry, fast-type passes, etc. Thus, no special equipment will be required to scan home printed tickets.

Such etickets can thus be purchased at home by a guest or by wholesalers and barcoded for single or multi-day admission to a venue on a particular date or dates. This may be done either through the internet or through a direct connection to the venue. When the eticket is scanned at the venue entrance, such as at a kiosk or turnstile, a replacement ticket is immediately printed which ticket can be used as a fast pass-type ticket, re-entry and any additional visits of a multi-day ticket.

The printing feature at the kiosk or turnstile at the venue entrance may be used for other purposes, such as fulfilling promotions offered by the venue (e.g., a promotion where if one “uses an annual passport to the venue on a particular day, he or she will receive a coupon for a 50% off meal discount at the venue or elsewhere).

The replacement ticket printers are of course built into the kiosk or turnstile at the venue entrance. The kiosk or turnstile is located at the point of admission, so that the guest with a home-printed ticket may proceed directly to the venue entrance like all other ticket holders. The ticket may also provide for admission into one or more attractions at the venue (i.e., a particular destination venue, which may be an amusement park, such as Disneyland in Anaheim, Calif., or may provide for admission to another venue, such as California Adventure, that is located in the amusement park area).

Guests and sales partners such as online travel agencies of certain venues are beginning to expect expedited ticket service for admission to the venue. Cost savings and product and marketing flexibility will be one of the benefits of this system. Guests are becoming more comfortable with online purchases of tickets, such as for airline travel and concerts, and may prefer to purchase tickets at home and print them at home rather than have tickets mailed to them.

Benefits to the venue, in addition to those mentioned above, are cost savings through decreased distribution costs, such as commissions and ticket handling, long run operational cost savings, product flexibility through ease of changing ticket offers and gated stores, and marketing and promotions flexibility through online store gating. The ability to deliver tickets quickly will lead to an increase in prearrival sales at the venue.

In addition to printing the replacement tickets at a turnstile or kiosk or the like, the venue may have roaming wireless ticket sellers at the venue which can print barcodes similar to those on etickets.

The system may be flexible enough to allow a guest to change the guest's eticket order to a will-call order if the guest forgets his or her eticket.

A brief summary of the system and method proposed herein is as follows:

A guest orders tickets via the Internet, paying with a credit card and selecting ‘E ticket/print at home’ or something similar as the delivery option. An email is sent to the guest along with instructions for printing the ticket or the guest is given a link to the ticket. Each ticket is printed on a separate page with a random bar code assigned by the system. When the page is presented at the venue entrance kiosk or turnstile), the bar code on the ticket is scanned and the guest's replacement ticket is immediately printed by a printer built into the exchange location. The E ticket bar code is no longer valid and the replacement ticket is used for the remainder of the Guest's stay.

In a preferred embodiment of the invention, the replacement ticket will be identical in size, weight, dimensions, type of planar material, such as paper or cardboard, coloring, printed information, electronic encoding, etc., as the type of ticket normally used at the venue to provide access to the same. In this manner, the replacement ticket is used for entry into the venue on one or more days, or to a related venue, or as a fast-type pass, just as if that ticket was purchased at the venue.

Although “home” is used throughout to discuss a user who may be at his or her home or residence and wishes to order an electronic ticket from his or her home, “home” is also used in its broader sense to include a home base or headquarters or place of origin of a potential user such as a store clerk, a travel agent, or hotel concierge, guest at the hotel, etc. “Attraction” may be a ride or show at the venue, or another amusement park or area remote from the venue. “Computer” is also used broadly to refer to any wired or wireless means, such as a personal digital assistant (pda), handheld computer, phone, etc., that can be used to access the Internet.

It can be seen that there is disclosed a method and system for accessing a venue on one or more days by using a computer to access the website of a remote server and purchasing online an electronic ticket to a venue or the like from the website of the remote server. A first printer is associated with either the computer or with the remote server for printing out a hard copy electronic ticket having a random bar code on the electronic ticket assigned by the server. The electronic ticket may then be presented at the entrance to the venue and receive a replacement ticket as they enter the venue, either at the turnstile or entry point to the venue, or directly in front thereof. Scanning means at the venue entrance scans the electronic ticket when presented at the venue entrance and decodes the information recorded on the bar code on the electronic ticket. A second printer is associated with the scanning means at the venue entrance for printing out a hard ticket replacing the electronic ticket and invalidating the electronic ticket.

The scanning means at the venue entrance may include a kiosk having the second printer associated therewith. The scanning means at the venue entrance may include a turnstile at the venue having the second printer associated therewith. The scanning means may include a roaming ticket seller, the ticket seller having the second printer associated therewith. The roaming ticket seller may carry around a portable computer and receipt printer able to connect to a wireless connection. The seller can thus roam freely within the venue depending on business needs and accept payment from a guest with a barcode thereon equivalent to an eticket. The guest will then take the receipt to the venue entrance where it is scanned and replaced similarly to an eticket. In this manner, the venue can sell tickets at any location, on or off site, without need for the equipment required to create a “standard” ticket.

The second printer will print out a replacement ticket at the venue entrance which conforms to the type of ticket normally used for admission at the venue. Such a ticket will conform substantially to the exact dimensions and type of planar material used as an admission ticket at the venue.

The computer may be located at the residence of the purchaser of the electronic ticket or at an office of the purchaser of the electronic ticket. The computer may be located at a hotel or a travel agency.

The venue may be an amusement park, a ticketed attraction, a theater, an opera house, a concert or a stage presentation.

Finally, the hard ticket may be a multi-day ticket valid for entrance to the venue on multiple days or valid for entrance to one or more attractions at the venue. Thus, guests will be able to visit the venue on their dates of choice. Finally, the hard ticket may include promotional information printed thereon.

Although a particular embodiment of the invention is disclosed, variations thereof may occur to an artisan and the scope of the invention should only be limited by the scope of the appended claims.

1. A system for accessing a venue on one or more days comprising:
computer means having access to the website of a remote server for purchasing online an electronic ticket to a venue or the like electronically from the website of the remote server;
first printing means associated with either the computer means or with the remote server for printing out a hard copy electronic ticket having a random bar code on said electronic ticket assigned by the server;
scanning means at the venue for scanning the electronic ticket when presented at the venue and decoding the information recorded on the bar code on the electronic ticket; and
second printing means associated with the scanning means at the venue for printing out a hard ticket replacing said electronic ticket and invalidating said electronic ticket.

2. The system of claim 1 wherein said server includes printing instructions means for conveying printing instructions to said computer means for printing said electronic ticket associated therewith.

3. The system of claim 1 wherein said scanning means at said venue includes a kiosk at the entrance to said venue having a printer associated therewith, said printer comprising said second printing means.

4. The system of claim 1 wherein said scanning means at said venue includes a turnstile at the entrance to said venue having a printer associated therewith, said printer comprising said second printing means.

5. The system of claim 1 wherein said scanning means at said venue includes a roaming ticket seller at said venue, said ticket seller having said computer means with a wireless connection associated therewith.

6. The system of claim 5 wherein said roaming ticket seller includes a printer adapted to print a ticket receipt with a barcode thereon comprising said electronic ticket.

7. The system of claim 1 wherein said second printing means for printing out a replacement ticket at said venue includes conforming means associated therewith for printing out a ticket conforming to the type of ticket normally used for admission at said venue.

8. The system of claim 1 wherein said conforming means for printing out a ticket at said venue conforming to the type of ticket normally used at said venue includes the step of printing out a ticket conforming substantially to the exact dimensions and type of planar material used as an admission ticket at the venue.

9. The system of claim 1 wherein said computer means is located at the residence of the purchaser of said electronic ticket.

10. The system of claim 1 wherein said computer means is located at an office of the purchaser of said electronic ticket.

11. The system of claim 1 wherein said computer means is located at a hotel.

12. The system of claim 1 wherein said computer means is located at a travel agency.

13. The system of claim 1 wherein said venue is an amusement park.

14. The system of claim 1 wherein said venue is a ticketed attraction.

15. The system of claim 14 wherein said ticketed attraction is a theater.

16. The system of claim 14 wherein said ticketed attraction is an opera house.

17. The system of claim 14 wherein said ticketed attraction is a concert.

18. The system of claim 14 wherein said ticketed attraction is a stage presentation.

19. The system of claim 1 where said hard ticket is a multi-day ticket valid for entrance to said venue on multiple days.

20. The system of claim 1 wherein said hard ticket is valid for entrance to one or more attractions at said venue.

21. The system of claim 1 wherein said hard ticket includes promotional information printed thereon.

22. A method for accessing a venue on one or more days comprising the steps of:
accessing a remote server to purchase an electronic ticket to said venue from a seller associated with said server;
preparing the information for an electronic ticket at the server based on information conveyed by the purchaser relating to said venue and time of attendance at said venue;
printing an electronic ticket having said information encoded thereon; and
reading said encoded information on said electronic ticket at said venue and substituting a replacement ticket providing access to said venue at said venue.

23. The method of claim 22 wherein the step of preparing the information for said electronic ticket includes the step of preparing information relating to a multi-day admission to said venue.

24. The method of claim 22 wherein the step of reading said encoded information includes the step of reading said information at a turnstile located at the entrance to said venue.

25. The method of claim 22 wherein the step of reading said encoded information includes the step of reading said encoded information at a kiosk located at the entrance to said venue.

26. The method of claim 22 wherein the step of reading said encoded information includes the step of reading said encoded information at a roaming ticket seller located at the venue.

27. The method of claim 22 wherein the step of substituting a replacement ticket includes the step of substituting, for the electronic ticket, a ticket conforming substantially to the dimensions and weight of planar materials for the type of admission ticket normally issued at the venue for entry thereto.

28. The method of claim 22 wherein the step of preparing said information includes the step of preparing information allowing access to one or more attractions located at said venue.

29. The method of claim 22 including the step of subsequently invalidating said electronic ticket when said replacement ticket is substituted therefor.

30. The method of claim 22 wherein said seller is a roaming seller at said venue, said roaming seller carrying a computer having a wireless connection to said remote server and a printer, the step of printing an electronic ticket including the step of said roaming seller printing said electronic ticket on said printer with barcode information thereon.
